(19) United States
(12) Patent Application Publication
(10) Pub. No.: US 2001/0030751 A1
(43) Pub. Date: Oct. 18, 2001

(54) Sensor and method for determining a property of each of a plurality of liquids

(76) Inventors: Dwight U. Bartholomew, Dallas, TX (US); Donald I. Stimpson, Haviland, KS (US)

Correspondence Address: Jacqueline J. Garner, Texas Instruments Incorporated, P. O. Box 655474, M/S 3999, Dallas, TX, 75265, US

(21) Appl. No.: 09/732,150

(22) Filed: Dec. 7, 2000

Related U.S. Application Data
(60) Provisional application No. 60/171,716, filed on Dec. 22, 1999.

(51) Int. Cl. G01N 21/55

(52) U.S. Cl. 356/445

(57) ABSTRACT

A sensor for determining a property of each of a plurality of liquids includes a plurality of electromagnetic radiation sources, each source generating a beam of electromagnetic radiation. The sensor also includes an array of electromagnetic radiation detectors. Each detector in the array is responsive to detect part of the beam of electromagnetic radiation generated by each source for making a determination of a property of the part of the beam detected. The sensor further includes a surface plasmon resonance layer and a reflecting surface. The surface plasmon resonance layer has a first surface and a second surface. The first surface can have a plurality of liquids deposited thereon, and the second surface reflects at least part of the beam of electromagnetic radiation generated by each source. The reflecting surface reflects the electromagnetic radiation reflected from the surface plasmon resonance layer towards the array of detectors. The response of the detectors for each beam determines the property of each liquid.

### TECHNICAL FIELD OF THE INVENTION

This invention relates to an apparatus and method for determining a property of each of a plurality of liquids and, in particular, to sensors and methods for determining a property of each of a plurality of liquids using surface plasmon resonance.

### BACKGROUND OF THE INVENTION

Surface plasmon resonance is an optical surface phenomenon that has been employed in sensors used in the fields of chemical, biological, and biomedical analysis. A surface plasmon is a surface charge density wave that exists at a conductor-dielectric boundary. Typically, the interface comprises a smooth surface of a transparent body having a thin metal film formed thereon.

The basis for the use of surface plasmon resonance for sensing is the fact that the oscillation of the surface plasmon is affected by the refractive index of the material adjacent to the conductor on the side opposite the dielectric. For a given wavelength of radiation, resonance, total internal reflection of the radiation, occurs when the angle of incidence of the radiation is greater than a particular value. Thus, for radiation striking the dielectric at the resonance angle, which is greater than the angle where total internal reflection commences, the intensity of the reflected radiation therefrom is minimized. As such, changes in the refractive index give rise to changes in the angle at which surface plasmon resonance occurs. Hence, by detecting the angle at which the minimum occurs, the refractive index of the material adjacent to the conductor can be determined.

The usefulness of this approach, however, has been limited due to mechanical alignment and cost issues associated with separate system components. Hence, a system that can provide a durable arrangement of system components while reducing the number of components required is desirable.

### SUMMARY OF THE INVENTION

In accordance with the present invention, at least some of the disadvantages and problems associated with previous sensors and methods for determining a property of each of a plurality of liquids have been substantially reduced or eliminated. The present invention provides a durable arrangement of system components for determining a property of each of a plurality of liquids while reducing the number of components required.

In one embodiment of the present invention, a sensor for determining a property of each of a plurality of liquids is provided. The sensor includes a plurality of electromagnetic radiation sources and an array of electromagnetic radiation detectors. Each source generates a beam of electromagnetic radiation, and each detector is responsive to detect part of the beam of electromagnetic radiation generated by each source for making a determination of a property of the part of the beam of electromagnetic radiation detected. The sensor also includes a surface plasmon resonance layer. The surface plasmon resonance layer has a first surface and a second surface. The first surface can have a plurality of liquids deposited thereon, each liquid associated with one of the sources, and the second surface reflects at least part of the beam of electromagnetic radiation generated by each source. The sensor further includes a reflecting surface. The reflecting surface reflects the electromagnetic radiation reflected from the second surface of the surface plasmon resonance layer towards the detectors. The response of the detectors for each beam determines the property of each liquid.

In another embodiment of the present the invention, a method for determining a property of each of a plurality of liquids is provided. The method begins with depositing a first liquid on the first surface of a surface plasmon resonance layer, the layer having a reflective second surface. A second liquid is also deposited on the first surface of the surface plasmon resonance layer. A first beam of electromagnetic radiation is then generated from a first electromagnetic radiation source, the first beam of electromagnetic radiation directed toward the second surface of the surface plasmon resonance layer opposite the first liquid. At least part of the first beam of electromagnetic radiation is reflected from the second surface of the surface plasmon resonance layer opposite the first liquid, and the electromagnetic radiation reflected from the second surface is again reflected. After this, the parts of the reflected electromagnetic radiation are detected with an array of electromagnetic radiation detectors. Next, a second beam of electromagnetic radiation is generated from a second electromagnetic radiation source, the second beam of electromagnetic radiation directed toward the second surface of the surface plasmon resonance layer opposite the second liquid. At least part of the second beam of electromagnetic radiation is reflected from the second surface of the surface plasmon resonance layer opposite the second liquid, and the electromagnetic radiation reflected from the second surface is again reflected. Finally, the parts of the reflected electromagnetic radiation are detected with the array of detectors.

### BRIEF DESCRIPTION OF THE DRAWINGS

For a more complete understanding of the present invention, and for further features and advantages, reference is now made to the following description taken in conjunction with the accompanying drawings, where like reference numerals represent like parts, in which:

FIG. 1 illustrates an embodiment of a sensor for determining a property of each of a plurality of liquids;

FIG. 2 illustrates the operation of the sensor for one of the liquids;

FIG. 3 illustrates an embodiment for a Surface Plasmon Resonance layer of the sensor;

FIG. 4 shows a view of the sensor through the rear wall and illustrates the operation of the cover of the sensor;

FIG. 5 illustrates an electronic block diagram for the sensor; and

FIG. 6 illustrates a method for determining a property of each of a plurality of liquids.

### DETAILED DESCRIPTION OF THE INVENTION

FIG. 1 illustrates an embodiment of a sensor 10 for determining a property of each of a plurality of liquids 20a-e (generally referred to as liquids 20). In general, sensor 10 includes a housing 30 that has a base 32, a wall 37, and a cover 42, which acts as a reflecting surface. Sensor 10 also includes a surface plasmon resonance (SPR) layer 40, which is a thin conducting surface, applied to the exterior surface of wall 37. Sensor 10 further includes a plurality of electromagnetic radiation sources 52a-e (generally referred to as electromagnetic radiation sources 52) and a plurality of electromagnetic radiation detectors 62 all mounted to base 32.

In operation, liquids 20 are first deposited on the exposed surface of SPR layer 40. Then, one of electromagnetic radiation sources 52 generates electromagnetic radiation that illuminates a portion of wall 37 and SPR layer 40 opposite one of liquids 20. SPR layer 40 reflects the electromagnetic radiation towards cover 42. Cover 42, because it is reflective, in turn, reflects the electromagnetic radiation from SPR layer 40 towards electromagnetic radiation detectors 62. Each electromagnetic radiation detector 62 detects a different portion of the electromagnetic radiation and determines a property of the portion of electromagnetic radiation detected. Based on these properties, a property of one of liquids 20 can be determined. This sequence is then repeated for each of electromagnetic radiation sources 52 and liquids 20.

In more detail, electromagnetic radiation sources 52 are arranged in an array 50 mounted to base 32. Array 50 of electromagnetic radiation source 52 is arranged in a source housing 54 having a pattern of apertures (not shown). The source housing 54 encases electromagnetic radiation sources 52 and by means of the pattern of apertures allows only a certain portion of the electromagnetic radiation generated by each electromagnetic radiation source 52 to propagate toward a specific portion of the interior surface of wall 37. Hence, source housing 54 partially controls patterning the electromagnetic radiation from each electromagnetic radiation source 52 into a beam. Electromagnetic radiation detectors 62 are also arranged in an array 60 mounted to base 32.

In operation, liquids 20 are applied to the exterior of SPR layer 40. Then, one of electromagnetic radiation sources 52 is activated, such as electromagnetic radiation source 52a. The activation of one of electromagnetic radiation sources 52 generates electromagnetic radiation that is a divergent beam upon passing through an aperture in source housing 54. The beam of electromagnetic radiation propagates towards wall 37. The beam of electromagnetic radiation then encounters wall 37 and SPR layer 40 opposite one of liquids 20, such as liquid 20a. At least part of the beam of electromagnetic radiation is then reflected from SPR layer 40 towards cover 42. When the reflected electromagnetic radiation strikes cover 42, it is reflected towards electromagnetic radiation detectors 62. Each electromagnetic radiation detector 62 detects a portion of the electromagnetic radiation beam and determines a property of the portion of the beam detected. Based on the property determined for each portion of the beam by electromagnetic radiation detectors 62, a property of one of liquids 20 can be determined.

In particular embodiments, electromagnetic radiation detectors 62 determine the intensity of each portion of the beam received. Based on the intensity of each portion of the beam, the refractive index of one of liquids 20 can be determined. The refractive index of a liquid may be used to determine any of a variety of properties of the liquid, such as its sugar content.

The components described to this point for sensor 10 are typically composed of a variety of elements that have a variety of physical properties and operating characteristics. Electromagnetic radiation sources 52 can be light emitting diodes (LEDs), laser diodes, or any other suitable source of electromagnetic radiation. In a particular embodiment, electromagnetic radiation sources 52 generate electromagnetic radiation in a wavelength range centered around 840 nanometers. In addition, any number of electromagnetic radiation sources 52 may be used as long as there is at least one for each liquid on SPR layer 40. In particular embodiments, array 50 of electromagnetic radiation sources 52 is linear. Base 32 and walls 34-37 of housing 30 can be made of a material that is transparent to the electromagnetic radiation generated by electromagnetic radiation sources 52, such as plastic, epoxy, polymethylmethacrylate, or polycarbonate. An epoxy marketed under the trademark name Epocast® 2013 Parts A/B by Furane Products Company is useful for radiation in the infrared range. SPR layer 40 can be composed of copper, silver, gold, aluminum, or any other suitable conductive material that can be made extremely thin, or materials that exhibit surface plasmons such as dielectric photonic bandgap materials. SPR layer 40 may vary in thickness from about two-hundred angstroms to six-hundred angstroms and still permit surface plasmon resonance to occur. Cover 42 can be a curved mirror, a faceted mirror, or any other type of device that can reflect the beams of electromagnetic radiation from all of electromagnetic radiation sources 52 onto electromagnetic radiation detectors 62 after reflecting from SPR layer 40. In particular embodiments, cover 42 can be a cylindrical mirror having a gold surface. In one embodiment, the radius of curvature of the cylindrical mirror is twice the distance from the array 60 of electromagnetic radiation detectors to the apex of cover 42. Electromagnetic radiation detectors 62 can be CMOS light detectors, charge coupled devices (CCDs), bolometers, or other devices capable of detecting portions of a beam of electromagnetic radiation and determining a property of the portion detected. For example, Texas Instruments, Inc. TITSL 1401 CMOS detectors may be used as electromagnetic radiation detectors 62. In particular embodiments, array 60 of detectors 62 is linear.

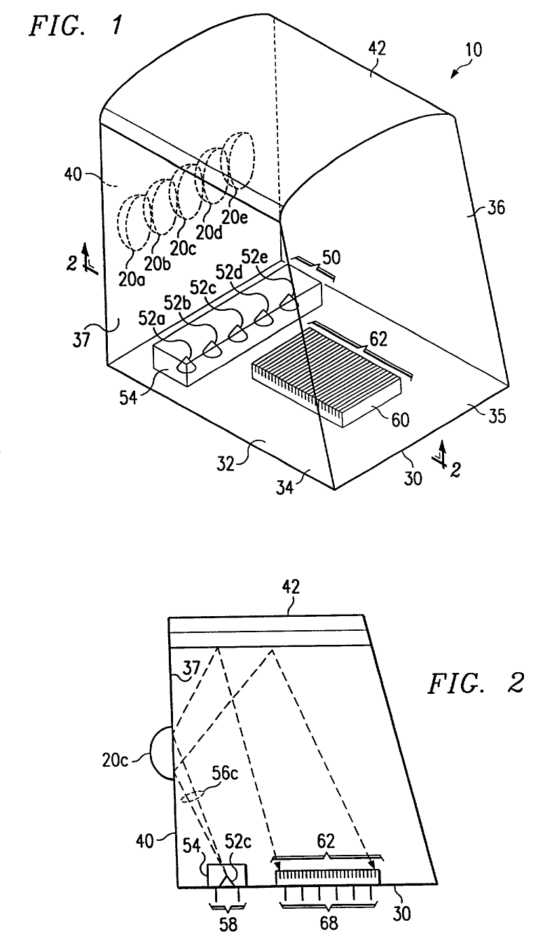

FIG. 2 illustrates the operation of sensor 10 for one of liquids 20, liquid 20c specifically, in more detail. Electromagnetic radiation source 52c generates electromagnetic radiation that is a divergent beam 56c upon passing through an aperture in source housing 54. After passing through source housing 54 the beam 56c propagates through the interior of housing 30 and encounters wall 37 and SPR layer 40 opposite liquid 20c. SPR layer 40 reflects at least part of beam 56c towards cover 42. Cover 42, in turn, reflects beam 56c towards electromagnetic radiation detectors 62. Each electromagnetic radiation detector 62 detects one ray of the beam 56c and determines a property of that ray. Based on the property determined for each ray of beam 56c, a property of liquid 20c can be determined.

FIG. 2 also illustrates source connectors 58 and detector connectors 68. Source connectors 58 are connected to a controller for control of electromagnetic radiation sources 52. Detector connectors 68 are used to transmit the output of electromagnetic radiation detectors 62 to a signal processor.

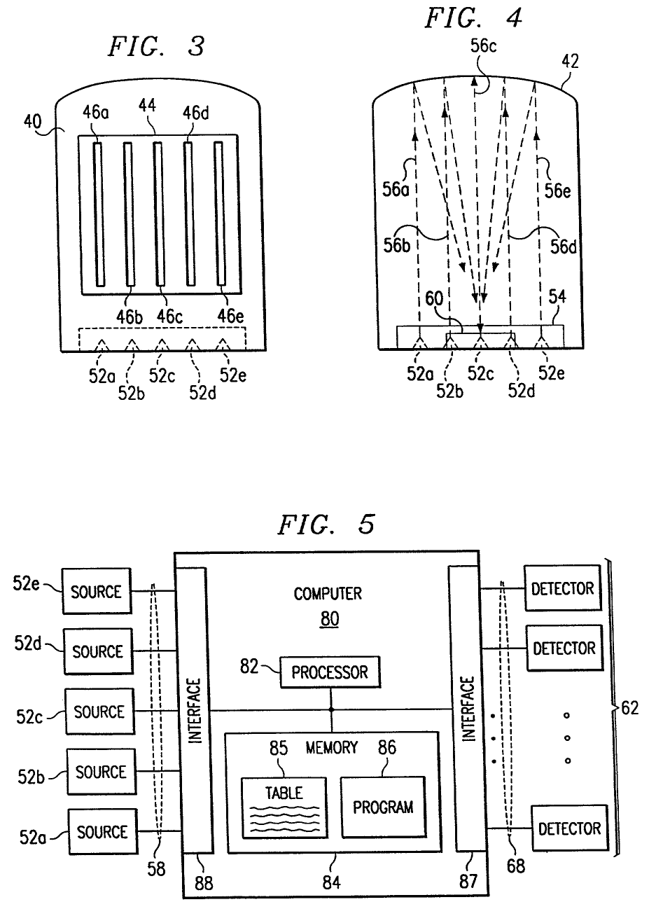

FIG. 3 illustrates an embodiment for SPR layer 40 of sensor 10. In this embodiment, SPR layer 40 includes a gasket 44 coupled to an exposed surface. Gasket 44 has a plurality of channels 46a-e that expose part of SPR layer 40. Channels 46a-e maintain separation between each of liquids 20 when deposited on SPR layer 40, thus ensuring that liquids 20 do not mix and contaminate each other. In particular embodiments, each of channels 46a-e is aligned with one of electromagnetic radiation sources 52. Gasket 44 can be composed of silicone rubber, teflon, or any other suitable material.

FIG. 4 shows a view of sensor 10 through wall 35 and illustrates the operation of cover 42. As can be seen, when one of electromagnetic radiation sources 52, such as electromagnetic radiation source 52a, generates electromagnetic radiation, the electromagnetic radiation is formed into one of beams 56, such as beam 56a, upon passing through source housing 54. At least some of the rays of the beam 56 are reflected from SPR layer 40 and then strike cover 42. Cover 42 reflects the beam 56 towards electromagnetic radiation detectors 62 (not shown) in array 60. This same sequence occurs for the rays of beam 56b from electromagnetic radiation source 52b, the rays of beam 56c from electromagnetic radiation source 52c, the rays of beam 56d from electromagnetic radiation source 52d, and the rays of beam 56e from electromagnetic radiation source 52e. Thus, cover 42 reflects all of the beams of electromagnetic radiation reflected from SPR layer 40 toward array 60 of electromagnetic radiation detectors 62.

FIG. 5 illustrates an electronic block diagram for sensor 10. The electronic block diagram for sensor 10 includes electromagnetic radiation sources 52 and electromagnetic radiation detectors 62, as discussed previously. Electromagnetic radiation sources 52 are connected to a computer 80 through source connectors 58. In addition, electromagnetic radiation detectors 62 are connected to computer 80 through detector connectors 68. Computer 80 includes a processor 82, a memory 84, an interface 87, and an interface 88, all interconnected to each other. Processor 82 controls the operations of sensor 10 based on a program 86 in memory 84. The properties of liquids 20 are stored in a table 85 in memory 84.

In operation, processor 82 first activates electromagnetic radiation source 52a by sending an appropriate electrical signal over one of source connectors 58. Electromagnetic radiation source 52a then generates a beam of electromagnetic radiation that propagates through the interior of housing 30, as previously discussed. Each electromagnetic radiation detector 62 detects a portion of the beam of electromagnetic radiation and generates an output to the computer 80 of a property for each part of the beam detected, as previously discussed. Processor 82 utilizes the property of each part of the beam of electromagnetic radiation from electromagnetic radiation detectors 62. Based on these properties, processor 82 determines a property of liquid 20a and stores this property in table 85. Then, the processor 82 individually activates each of the remaining radiation sources 52 and determines the property of each of the remaining liquids 20 to be analyzed.

Processor 82 can be a complex instruction set computer (CISC), a reduced instruction set computer (RISC), or any other type of available computer. Memory 84 may be random access memory (RAM), read-only memory (ROM), compact disc read-only memory (CD-ROM), programmable read-only memory (PROM), registers, or any other type of electromagnetic or optical volatile or non-volatile computer memory.

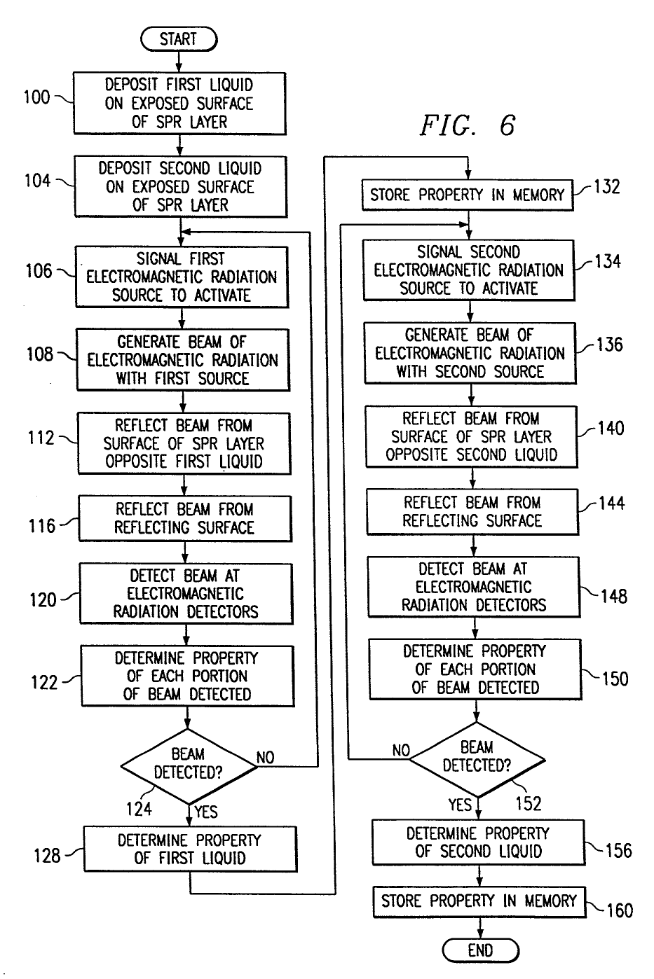

FIG. 6 illustrates a method for determining a property of each of a plurality of liquids, such as liquids 20. A first liquid, such as liquid 20a, is deposited during sequence 100 on the exposed surface of an SPR layer, such as SPR layer 40. A second liquid, such as liquid 20b, is also deposited on the exposed surface of the SPR layer during sequence 104. Next, a signal is sent to activate a first electromagnetic radiation source, such as electromagnetic radiation source 52a, during sequence 106. Then, during sequence 108, a beam of electromagnetic radiation is generated by the first electromagnetic radiation source. At least part of the beam of electromagnetic radiation is reflected from the surface of the SPR layer opposite the first liquid during sequence 112. Then, the beam of electromagnetic radiation is reflected from a reflecting surface, such as cover 42, during sequence 116. During sequence 120, the beam of electromagnetic radiation is detected by a plurality of electromagnetic radiation detectors, such as electromagnetic radiation detectors 62. Next, during sequence 122 the electromagnetic radiation detectors determine a property of each portion of the detected beam. During sequence 124, a computer, such as computer 80, determines whether the electromagnetic radiation detectors detected the beam of electromagnetic radiation. If the beam of electromagnetic radiation was not detected by the electromagnetic radiation detectors, sequences 106, 108, 112, 116, 120, 122, and 124 are repeated.

If, however, the computer determines during sequence 124 that the electromagnetic radiation detectors have detected the electromagnetic radiation beam, the computer determines a property of the first liquid during sequence 128, based on the properties of the portions of the electromagnetic beam. After this, the computer stores the property of the first liquid in memory during sequence 132.

Next, a signal is sent to activate a second electromagnetic radiation source, such as electromagnetic radiation source 52b, during sequence 134. The second electromagnetic radiation source generates during sequence 136 a beam of electromagnetic radiation. This beam of electromagnetic radiation is reflected during sequence 140 from the surface of SPR layer 40 opposite the second liquid. Then, the second beam of electromagnetic radiation is reflected at step 144 from cover 42. The beam of electromagnetic radiation is detected during sequence 148 by the electromagnetic radiation detectors. Each electromagnetic radiation detector determines a property of each portion of the beam detected during sequence 150. During sequence 152, the computer determines whether the electromagnetic radiation detectors detected the beam of electromagnetic radiation. If the beam was not detected, sequences 134, 136, 140, 144, 148, 150, and 152 are repeated. If, however, the beam was detected, the computer determines during sequence 156 the property of the second liquid. After this, the computer stores during sequence 160 the property in memory.

Although an embodiment of sensor 10 has been illustrated and described with reference to FIG. 1, sensor 10 could be constructed in a variety of other configurations. The SPR layer 40 could have more or less liquids 20 deposited on it, meaning that more or less electromagnetic radiation sources 52 would be required. In addition, electromagnetic radiation detectors 62 do not have to be in array 60. Thus, the invention contemplates any number of spatial arrangements of electromagnetic radiation sources 52, SPR layer 40, cover 42, and electromagnetic radiation detectors 62 so that the beams of electromagnetic radiation from all electromagnetic radiation sources 52 encounter electromagnetic radiation detectors 62.

Although several embodiments of the invention have been discussed, a variety of additions, deletions, substitutions, and alterations may be readily suggested to one of skill in the art. It is intended that such additions, deletions, substitutions, and alterations be encompassed within the scope of the following claims.

What is claimed is:

1. A sensor for determining a property of each of a plurality of liquids, comprising:
a plurality of electromagnetic radiation sources, each source generating a beam of electromagnetic radiation;
an array of electromagnetic radiation detectors, each detector responsive to detect part of the beam of electromagnetic radiation generated by each source for making a determination of a property of the part of the beam of electromagnetic radiation detected;
a surface plasmon resonance layer comprising a first surface and a second surface, the first surface for having a plurality of liquids deposited thereon, each liquid associated with one of the sources, the second surface reflecting at least part of the beam of electromagnetic radiation generated by each source; and
a reflecting surface, the reflecting surface reflecting the electromagnetic radiation reflected from the second surface of the surface plasmon resonance layer towards the detectors;
wherein the response of the detectors for each beam determines the property of each liquid.

2. The sensor of claim 1, wherein each detector operates in response to the intensity of the part of the beam of electromagnetic radiation detected for making a determination of a property of the part of the beam of electromagnetic radiation detected.

3. The sensor of claim 1, further comprising a computer coupled to the plurality of radiation sources and the array of radiation detectors, the computer activating each source individually to determine a property of each liquid based on the property determined for each part of the beam of electromagnetic radiation.

4. The sensor of claim 3, wherein the computer determines the refractive index of each liquid based on the intensity of each part of the beam of electromagnetic radiation detected by each detector, the refractive index of each liquid determining the property of each liquid based on each part of the beam of electromagnetic radiation.

5. The sensor of claim 1, wherein:
the plurality of sources comprise a substantially linearly aligned plurality of radiation sources; and
the array of detectors comprise a linear array of detectors aligned substantially perpendicular to the alignment of the plurality of sources.

6. The sensor of claim 1, wherein each of the plurality of sources generates electromagnetic radiation within a given wavelength range.

7. The sensor of claim 6, wherein the center of the wavelength range is 840 nanometers.

8. The sensor of claim 1, wherein the detectors comprise silicon photodiodes.

9. The sensor of claim 1, wherein the reflecting surface comprises a curved mirror.

10. The sensor of claim 9, wherein the mirror comprises a circular cross-section.

11. The sensor of claim 9, wherein the mirror comprises a gold surface.

12. The sensor of claim 1, wherein the reflecting surface comprises a faceted mirror.

13. The sensor of claim 1, wherein the surface plasmon resonance layer comprises a gasket attached to the first surface, the gasket separating the plurality of liquids from each other.

14. A method for determining a property of each of a plurality of liquids, the method comprising:
depositing a first liquid on the first surface of a surface plasmon resonance layer, the layer having a reflective second surface;
depositing a second liquid on the first surface of the surface plasmon resonance layer;
generating a first beam of electromagnetic radiation from a first electromagnetic radiation source, the first beam of electromagnetic radiation directed toward the second surface of the surface plasmon resonance layer opposite the first liquid;
reflecting at least part of the first beam of electromagnetic radiation from the second surface of the surface plasmon resonance layer opposite the first liquid;
reflecting the electromagnetic radiation reflected from the second surface of the surface plasmon layer;
detecting parts of the reflected electromagnetic radiation with an array of electromagnetic radiation detectors;
generating a second beam of electromagnetic radiation from a second electromagnetic radiation source, the second beam of electromagnetic radiation directed toward the second surface of the surface plasmon resonance layer opposite the second liquid;
reflecting at least part of the second beam of electromagnetic radiation from the second surface of the surface plasmon resonance layer opposite the second liquid;
reflecting the electromagnetic radiation reflected from the second surface of the surface plasmon layer; and
detecting parts of the reflected electromagnetic radiation with the array of radiation detectors.

15. The method of claim 14, further comprising:
determining a property of each part of the first beam of electromagnetic radiation detected by each detector;
determining a property of the first liquid based on the determined properties of the parts of the first beam of electromagnetic radiation;
determining a property of each part of the second beam of electromagnetic radiation detected by each detector; and
determining a property of the second liquid based on the determined properties of the parts of the second beam of electromagnetic radiation.

16. The method of claim 14, wherein:
determining a property of each part of the first beam of electromagnetic radiation detected by each detector comprises determining the intensity of the electromagnetic radiation received at each detector; and
determining a property of the first liquid based on the determined properties of the parts of the first beam of electromagnetic radiation comprises determining the refractive index of the first liquid based on the intensity of each part of the electromagnetic radiation.

17. The method of claim 14, wherein each source generates electromagnetic radiation in a given wavelength range.

18. The method of claim 14, wherein reflecting the electromagnetic radiation comprises reflecting the radiation from a curved mirror.

19. The method of claim 18, wherein the mirror comprises a circular cross-section.

20. The method of claim 14, wherein reflecting the electromagnetic radiation comprises reflecting the radiation from a faceted mirror.

21. A sensor for determining a property of each of a plurality of liquids, comprising:
a base;
a linear array of electromagnetic radiation sources coupled to the base, each source generating a beam of electromagnetic radiation;
a linear array of electromagnetic radiation detectors coupled to the base and aligned substantially perpendicular to the alignment of the sources, each detector responsive to detect part of the beam of electromagnetic radiation generated by each source for making a determination of a property of the part of the beam of electromagnetic radiation detected;
a wall coupled to the base;
a surface plasmon resonance layer coupled to the wall, the surface plasmon resonance layer comprising a first surface and a second surface, the first surface for having a plurality of liquids deposited thereon, each liquid associated with one of the sources, the second surface reflecting at least part of the beam of electromagnetic radiation generated by each source; and
a cover coupled to the wall, the cover comprising a reflecting surface, the reflecting surface reflecting the electromagnetic radiation reflected from the second surface of the surface plasmon resonance layer towards the detectors;
wherein the response of the detectors for each beam determines the property of each liquid.

22. The sensor of claim 21, wherein each detector operates in response to the intensity of the part of the beam of electromagnetic radiation detected for making a determination of a property of the part of the beam of electromagnetic radiation detected.

23. The sensor of claim 21, further comprising a computer coupled to the sources and the detectors, the computer activating each source individually to determine a property of each liquid based on the determined property of each part of the beam of electromagnetic radiation.

24. The sensor of claim 23, wherein the computer determines the refractive index of each liquid based on the intensity of each part of the beam of electromagnetic radiation detected by each detector, the refractive index of each liquid determining the property of each liquid based on each part of the beam of electromagnetic radiation.

25. The sensor of claim 21, wherein each source produces electromagnetic radiation within a given wavelength range.

26. The sensor of claim 21, wherein the detectors comprise silicon photodiodes.

27. The sensor of claim 21, wherein the reflecting surface comprises a curved mirror.

28. The sensor of claim 27, wherein the mirror comprises a circular cross-section.

29. The sensor of claim 27, wherein the mirror comprises a gold surface.

30. The sensor of claim 21, wherein the reflecting surface comprises a faceted mirror.
